(19) United States
(12) Patent Application Publication
(10) Pub. No.: US 2004/0232260 A1
(43) Pub. Date: Nov. 25, 2004

(54) Pressure-storing device with a sealing mechanism for a plurality of fluid chambers

(76) Inventor: Hsi-Tsai Chen, Taichung City (TW)

Correspondence Address: KRAMER, LEVIN, NAFTALIS & FRANKEL LLP, 919 Third Avenue, New York, NY, 10022-3852, US

(21) Appl. No.: 10/633,184

(22) Filed: Aug. 1, 2003

(30) Foreign Application Priority Data
May 1, 2003 (TW) 092208031

(51) Int. Cl. B05B 1/30

(52) U.S. Cl. 239/569

(57) ABSTRACT

A sealing mechanism for a fluid-containing member of a pressure-storing device includes nozzle members, a fluid intake unit, and a control unit. Each nozzle member is coupled to a respective fluid inlet of the fluid-containing member, and includes a hollow nozzle body and a valve unit operable so as to move from a blocking position for blocking fluid flow through the respective fluid inlet to an unblocking position for permitting fluid flow through the respective fluid inlet. The fluid intake unit is coupled to the fluid-containing member such that the nozzle members are disposed between the fluid intake unit and the fluid inlets. The control unit is operable so as to drive movement of the valve units of the nozzle members from the blocking position to the unblocking position.

### CROSS-REFERENCE TO RELATED APPLICATION

This application claims priority of Taiwanese application no. 092208031, filed on May 1, 2003.

### BACKGROUND OF THE INVENTION

1. Field of the Invention

The present invention relates to a pressure-storing device, more particularly to a pressure-storing device with a sealing mechanism for a plurality of fluid chambers.

2. Description of the Related Art

Pressure-storing devices are in wide use. Examples thereof can be seen in various applications, such as pneumatic tires, airshafts for holding rolls of web material, etc. In practice, a pressure-storing device usually takes the form of a fluid-containing member formed with a fluid chamber and provided with a nozzle member for controlling charging and discharging of fluid. Numerous disadvantages are prevalent in the conventional pressure-storing devices. For example, when the fluid-containing member is in the form of a vehicle tire, such as one mounted on a bicycle, a motorcycle, a car, etc., the pressure of the fluid contained in the tire must be maintained at a certain level as to ensure smooth and safe movement of the vehicle. However, without any warning signs in advance, a flat tire maybe caused abruptly by tire wear or sharp objects, and thus puts the driver in a dangerous situation. Moreover, when the fluid-containing member is in the form of an airshaft, the fluid-containing member includes a plurality of fluid chambers that are required to be inflated individually, which is a very inconvenient procedure. Furthermore, the probability of air leak in an airshaft is rather high. When air leak occurs during production, the products manufactured with the use of the leaking airshaft will be defective, and incurred expenses attributed to the leaking airshaft are rather high.

### SUMMARY OF THE INVENTION

Therefore, the object of the present invention is to provide a pressure-storing device with a sealing mechanism for a plurality of fluid chambers so as to overcome the aforesaid drawbacks associated with the prior art.

Accordingly, a pressure-storing device of the present invention comprises a fluid-containing member and a sealing mechanism. The fluid-containing member is formed with a plurality of fluid chambers, and has a plurality of fluid inlets in fluid communication with the fluid chambers, respectively. The sealing mechanism includes a plurality of nozzle members, a fluid intake unit, and a control unit.

Each of the nozzle members is coupled to a respective one of the fluid inlets, and includes a hollow nozzle body and a valve unit disposed in the nozzle body and operable so as to move from a blocking position for blocking fluid flow through the respective one of the fluid inlets to an unblocking position for permitting fluid flow through the respective one of the fluid inlets.

The fluid intake unit is coupled to the fluid-containing member such that each of the nozzle members is disposed between the fluid intake unit and the respective one of the fluid inlets. The fluid intake unit cooperates with the fluid-containing member to confine a fluid space that is disposed on one side of each of the nozzle members opposite to the respective one of the fluid inlets.

The control unit extends into the fluid space and is operable so as to drive movement of the valve units of the nozzle members from the blocking position to the unblocking position.

### BRIEF DESCRIPTION OF THE DRAWINGS

Other features and advantages of the present invention will become apparent in the following detailed description of the preferred embodiment with reference to the accompanying drawings, of which:

FIG. 1 is a fragmentary exploded perspective view illustrating the preferred embodiment of a pressure-storing device according to the present invention;

FIG. 2 is a fragmentary assembled partially cutaway perspective view of the preferred embodiment in a sealed state;

FIG. 3 is a magnified view of a portion of FIG. 2, illustrating a detailed structure of a nozzle member; and

FIG. 4 is a view similar to FIG. 2, but illustrating a pumping state of the preferred embodiment.

### DETAILED DESCRIPTION OF THE PREFERRED EMBODIMENT

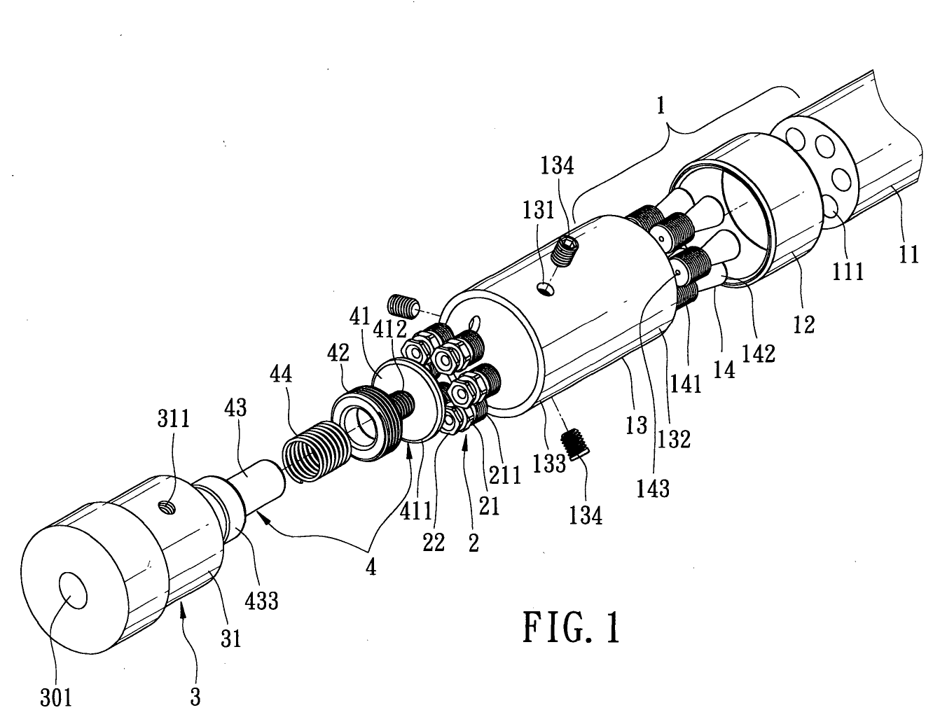

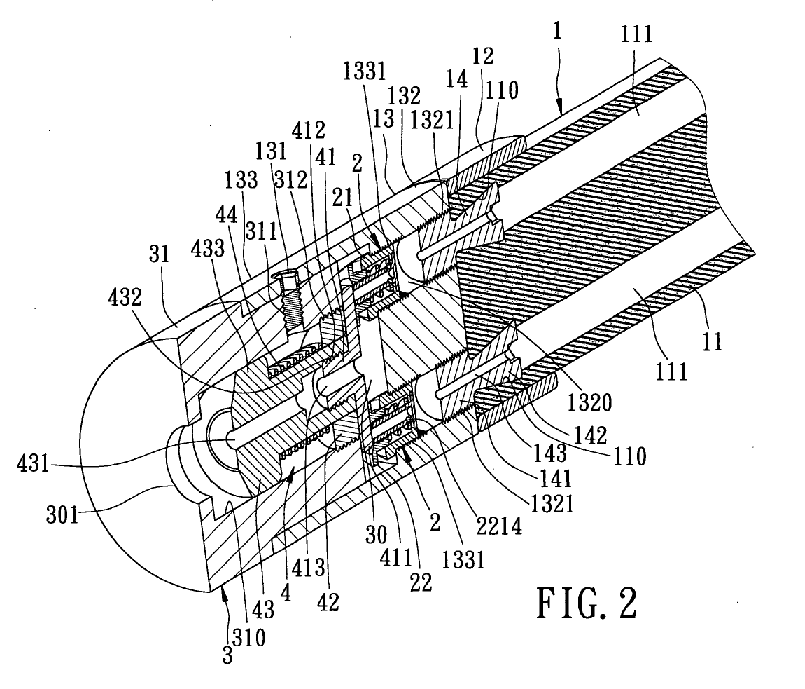

Referring to FIGS. 1 to 4, the pressure-storing device of this invention is shown to be embodied in an airshaft that includes a fluid-containing member 1 and a sealing mechanism. The sealing mechanism includes a plurality of nozzle members 2, a fluid intake unit 3, and a control unit 4.

The fluid-containing member 1 includes a resilient bladder unit 11, a clamping ring 12, a tubular coupling member 13, and a plurality of connecting plugs 14.

The bladder unit 11 confines a plurality of fluid chambers 111 that are fluidly isolated from each other. The bladder unit 11 is further formed with a plurality of chamber holes 110 for fluid access to the fluid chambers 111, respectively.

Each of the connecting plugs 14 has an anchor portion 141 and an insert portion 142 opposite to the anchor portion 141 in an axial direction. The insert portion 142 of each of the connecting plugs 14 is inserted into and is fittingly retained in a respective one of the chamber holes 110. Preferably, the insert portion 142 of each of the connecting plugs 14 gradually diverges in the axial direction away from the anchor portion 141. The anchor portion 141 of each of the connecting plugs 14 is disposed externally of a respective one of the fluid chambers 111. Each of the connecting plugs 14 is further formed with an axial through hole 143 that extends in the axial direction.

The clamping ring 12 is sleeved on the bladder unit 11 to tighten engagement between the bladder unit 11 and the insert portions 142 of the connecting plugs 14.

The tubular coupling member 13 has an intake coupling portion 133 coupled to the fluid intake unit 3, and a bladder coupling portion 132 opposite to the intake coupling portion 133 in the axial direction and formed with a plurality of fluid inlets 1320. A fluid space 30 is formed in the tubular coupling member 13 between the fluid intake unit 3 and the bladder coupling portion 132. Each of the fluid inlets 1320 has internally threaded proximate and distal sections 1321, 1331 respectively proximate to and distal from the bladder unit 11. The anchor portion 141 of each of the connecting plugs 14 is externally threaded and is coupled to the bladder coupling portion 132 at the proximate section 1321 of a respective one of the fluid inlets 1320. Accordingly, each of the fluid inlets 1320 is in fluid communication with a respective one of the fluid chambers 111 through the axial through hole 143 in the respective one of the connecting plugs 14.

Each of the nozzle members 2 is coupled to a respective one of the fluid inlets 1320, and includes a hollow nozzle body 21 and a valve unit 22 disposed in the nozzle body 21.

The nozzle body 21 of each of the nozzle members 2 is tubular, confines a nozzle space 212 therein, and is formed with an external thread 211 for coupling threadedly with the bladder coupling portion 132 at the distal section 1331 of the respective one of the fluid inlets 1320. The nozzle body 21 of each of the nozzle members 2 is further formed with an annular valve seat 213 that extends radially and inwardly therefrom.

The valve unit 22 of each of the nozzle members 2 includes a tubular valve stem 221, a valve piece 2213, a press cap 2211, and a biasing spring 222.

The valve stem 221 is disposed in the nozzle body 21, and has proximate and distal stem portions opposite to each other in an axial direction and respectively proximate to and distal from the fluid space 30. The valve stem 221 confines a stem space 2212 therein that is in fluid communication with the fluid space 30, and is further formed with a radial fluid hole 2214. The distal stem portion passes through the valve seat 213. The valve piece 2213 is connected to the distal stem portion. The proximate stem portion extends outwardly of the nozzle body 21 and into the fluid space 30. The press cap 2211 is connected threadedly to the proximate stem portion and is acted upon by the control unit 4, which will be described in greater detail in the succeeding paragraphs. The biasing spring 222 includes a coiled compression spring disposed in the nozzle space 212, sleeved on the valve stem 221, and having opposite ends that act on the press cap 2211 and the valve seat 213, respectively. The biasing spring 222 serves to bias the valve stem 221 to cause the valve piece 2213 to abut against the valve seat 213, thereby preventing fluid flow through the fluid space 30, the stem space 2212, the fluid hole 2214 and the fluid inlet 1320, and thereby disposing the valve unit 22 in a blocking position.

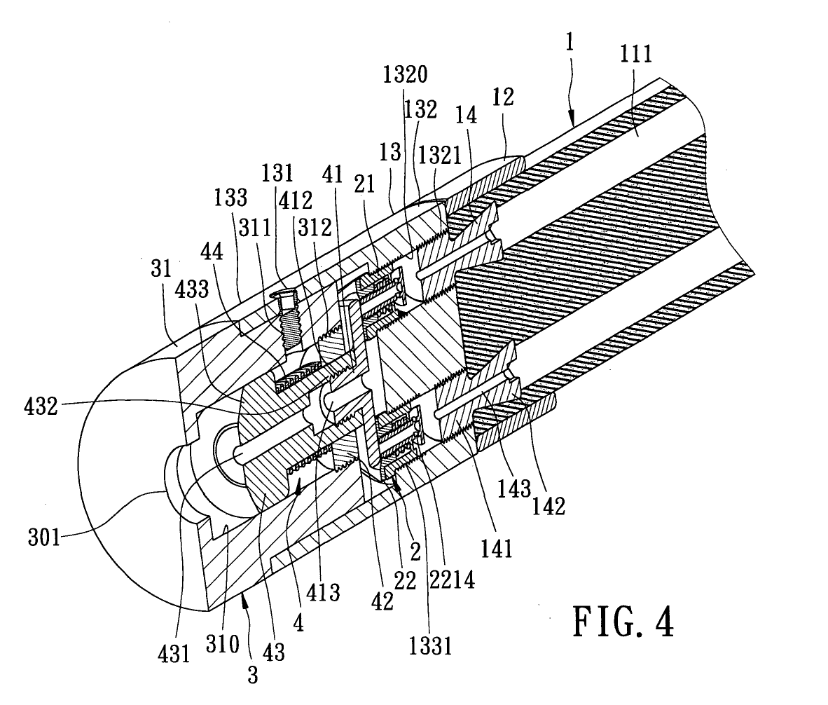

The control unit 4 extends into the fluid space 30, and is operable so as to force the proximate stem portion of the valve stem 221 of each of the valve units 22 into the respective nozzle space 212 against biasing action of the respective biasing spring 222 such that the valve pieces 2213 of the valve units 22 are simultaneously moved away from the respective valve seat 213 to permit fluid flow through the fluid space 30, the stem spaces 2212, the fluid holes 2214 and the fluid inlets 1320, thereby disposing the valve units 22 in an unblocking position, as best shown in FIG. 4.

The fluid intake unit 3 includes a coupling tube 31 formed with a fluid intake passage 310 that extends in an axial direction and that is in fluid communication with the fluid space 30. The coupling tube 31 has an intake hole 301 registered with the fluid intake passage 310 and adapted for connecting to a fluid pumping device (not shown), and an internally threaded end section 312 opposite to the intake hole 301. The intake coupling portion 133 of the tubular coupling member 13 of the fluid-containing member 1 is further formed with a plurality of radial fastener holes 131. The coupling tube 31 is formed with a plurality of threaded holes 311 that are registered with the fastener holes 131 when the coupling tube 31 is extended into the tubular coupling member 13. A plurality of screws 134 extend into the fastener holes 131 and engage the threaded holes 311 so as to be couple the coupling tube 31 of the fluid intake unit 3 to the tubular coupling member 13 of the fluid-containing member 1.

The control unit 4 includes a press member 41, an annular spring seat 42, a drive member 43, and a biasing member 44.

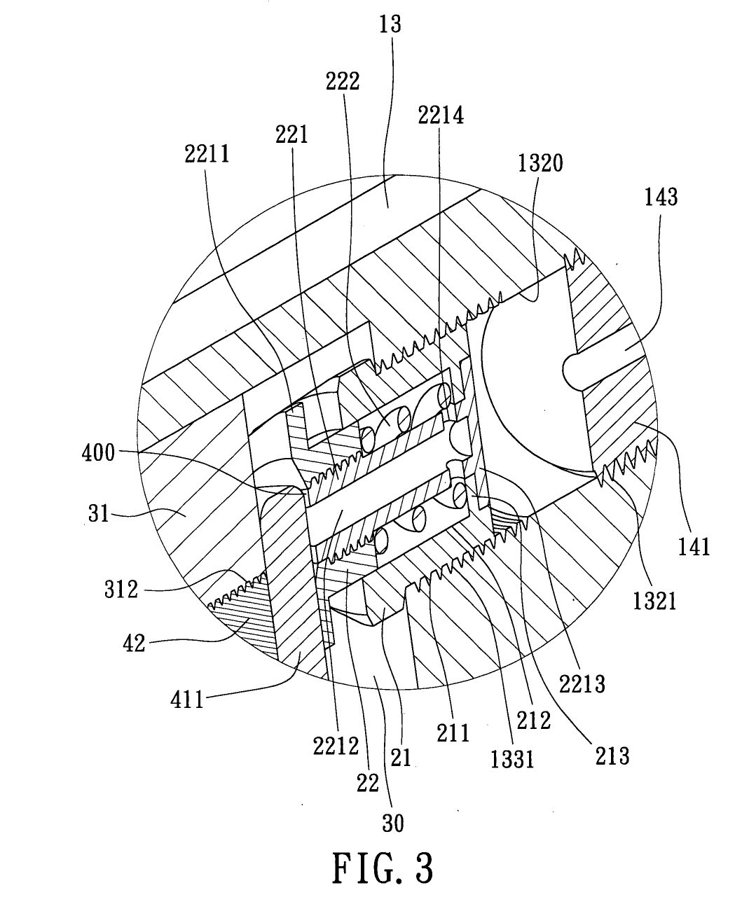

The press member 41 is disposed in the fluid space 30, and is formed with a through hole 413 that is in fluid communication with the fluid space 30. The press member 41 includes a press plate portion 411 that is disposed to abut against the press cap 2211 of the valve unit 22 of each of the nozzle members 2, and a threaded coupling portion 412 that extends into the fluid intake passage 310. It should be noted herein that a clearance 400 (see FIG. 3) is formed between the press plate portion 411 and the press cap 2211 of the valve unit 22 of each of the nozzle members 2 so as to maintain fluid communication between the fluid space 30 and the respective stem space 2212.

The drive member 43 is disposed in the fluid intake passage 310, and is formed with a fluid channel 431 that is in fluid communication with the fluid intake passage 310. The drive member 43 is formed with an internally threaded section 432 coupled to the threaded coupling portion 412 of the press member 41 such that the fluid channel 431 is in fluid communication with the through hole 413 in the press member 41.

The annular spring seat 42 is threaded externally and is retained in the end section 312 of the coupling tube 31. The drive member 43 extends through the spring seat 42 and is formed with a radial flange 433 spaced apart from the spring seat 42 in the axial direction. The biasing member 44 is sleeved on the drive member 43, and has opposite ends that act on the radial flange 433 of the drive member 43 and the spring seat 42, respectively. The biasing member 44 biases the drive member 43 to move the press plate portion 411 of the press member 41 in a direction away from the nozzle members 2.

During a fluid pumping operation, an external force is exerted upon the drive member 43 of the control unit 4 (for example, by a nozzle of the fluid pumping device) so as to enable the press plate portion 411 of the press member 41 to abut against the press caps 2211 of the valve stems 221 of the valve units 22 of the nozzle members 2. At this time, the valve stems 221 are displaced such that the fluid holes 2214 are in fluid communication with the fluid inlets 1320. In this way, fluid from the fluid pumping device (not shown) can continuously flow into the fluid chambers 111 of the bladder unit 11 for pressure storing. At the end of the fluid pumping operation, the external force on the drive member 43 is removed, and the valve stems 221 will be restored back to their initial blocking positions by virtue of the restoring action of the biasing springs 222. As a result, the fluid holes 2214 are blocked from fluid communication with the fluid inlets 1320 so that the purpose of pressure storing can be served accordingly.

The operation for releasing pressure in the fluid-containing member 1 proceeds in a manner similar to the aforesaid pumping operation.

In contrast with a conventional airshaft, only one pressure-storing operation is performed for the isolated fluid chambers of the bladder unit without the need to disassemble the pressure-storing device of this invention during the production of rolls of web material to result in labor and time savings.

Furthermore, although the pressure-storing device of this invention is illustrated using an airshaft, the fluid-containing member can be modified to be in the form of a tire with a plurality of isolated fluid chambers. In this case, when one of the fluid chambers ruptures, as long as the other fluid chambers can function, the problem of a flat tire can be alleviated.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

I claim:

1. A pressure-storing device comprising:
a fluid-containing member formed with a plurality of fluid chambers and having a plurality of fluid inlets in fluid communication with said fluid chambers, respectively; and
a sealing mechanism including
a plurality of nozzle members, each of which is coupled to a respective one of said fluid inlets, each of said nozzle members including a hollow nozzle body and a valve unit disposed in said nozzle body and operable so as to move from a blocking position for blocking fluid flow through the respective one of said fluid inlets to an unblocking position for permitting fluid flow through the respective one of said fluid inlets,
a fluid intake unit coupled to said fluid-containing member such that each of said nozzle members is disposed between said fluid intake unit and the respective one of said fluid inlets, said fluid intake unit cooperating with said fluid-containing member to confine a fluid space that is disposed on one side of each of said nozzle members opposite to the respective one of said fluid inlets, and
a control unit extending into said fluid space and operable so as to drive movement of said valve units of said nozzle members from the blocking position to the unblocking position.

2. The pressure-storing device as claimed in claim 1, wherein said fluid-containing member includes:
a resilient bladder unit that confines said fluid chambers and that is formed with a plurality of chamber holes for fluid access to said fluid chambers, respectively;
a plurality of connecting plugs, each of which has an anchor portion and an insert portion opposite to said anchor portion in an axial direction, said insert portion of each of said connecting plugs being inserted into and being fittingly retained in a respective one of said chamber holes, said anchor portion of each of said connecting plugs being disposed externally of a respective one of said fluid chambers, each of said connecting plugs being further formed with an axial through hole that extends in the axial direction; and
a tubular coupling member having an intake coupling portion coupled to said fluid intake unit, and a bladder coupling portion opposite to said intake coupling portion in the axial direction and formed with said fluid inlets, said fluid space being formed between said fluid intake unit and said bladder coupling portion, each of said fluid inlets having proximate and distal sections respectively proximate to and distal from said bladder unit, said anchor portion of each of said connecting plugs being coupled to said bladder coupling portion at said proximate section of a respective one of said fluid inlets, said nozzle body of each of said nozzle members being coupled to said bladder coupling portion at said distal section of the respective one of said fluid inlets.
